(19) United States
(12) Patent Application Publication
(10) Pub. No.: US 2021/0066749 A1
(43) Pub. Date: Mar. 4, 2021

(54) CONCRETE BATTERY FOR LARGE STRUCTURAL APPLICATIONS HAVING ANODE AND CATHODE PORTIONS WITH A COEFFICIENT OF THERMAL EXPANSION COMPATIBLE WITH CEMENT

(71) Applicant: Jeremy Laros, Willow Creek, CA (US)

(72) Inventor: Jeremy Laros, Willow Creek, CA (US)

(21) Appl. No.: 17/005,234

(22) Filed: Aug. 27, 2020

Related U.S. Application Data
(60) Provisional application No. 62/892,492, filed on Aug. 27, 2019.

(51) Int. Cl. H01M 10/0562; H01M 10/04; H01M 10/02

(52) U.S. Cl. CPC H01M 10/0562; H01M 10/0413; H01M 10/02; H01M 2300/0091; H01M 2300/0071; H01M 2300/008; H01M 2220/10; H01M 2300/0068

(57) ABSTRACT

Embodiments of the present disclosure relate to concrete batteries for large structural applications, where the materials used for the concrete electrolyte and the electrodes have a coefficient of linear thermal expansion within acceptable ranges to prevent cracking or spalling, and further where the electrodes provide enhanced structural support for the concrete electrolyte, such that the concrete battery can be used for load-bearing applications.

### CROSS-REFERENCE TO RELATED APPLICATIONS

This application claims priority to U.S. Provisional Patent Application No. 62/892,492; filed on Aug. 27, 2019, which is incorporated by reference herein in its entirety.

### FIELD OF THE DISCLOSURE

Embodiments disclosed in the present application relate to improvements in concrete building components for energy storage. In particular, embodiments disclosed herein relate to improved concrete batteries for large structural applications having anode and cathode portions with a coefficient of thermal expansion that is compatible with common Portland cement.

### BACKGROUND

Historically, structures such as roadways and buildings, etc., have not incorporated any usable electric energy storage components. The more recent battery systems used on buildings generally comprise self-contained units that store energy when connected to solar panels generating electric energy during sunny days. These units then provide energy to electric appliances and equipment, etc., during nights and days when no solar energy can be generated due to weather. However, these units are attached to buildings as accessories. They are not an integral part of the building structure and cannot provide required structural stability and strength.

Cement-based concrete, by volume, is the most widely used construction and building material in the world. When it is used to create buildings, roads, bridges, tunnels, railways, airports, spaceport launch pads, etc., concrete provides excellent structural integrity.

It is known that cured and hardened cement under certain conditions generates galvanic current. Commonly, civil engineers and builders try to reduce or ameliorate this current, as it can be the cause of cracking, spalling, and chemical decomposition and weakening of rebar and concrete structures.

In recent years, some researchers have begun to experiment with this property in an effort to develop concrete as a solid-state type of electrolyte in a battery-like device. The goal of such investigation is to be able to pair the concrete electrolyte with proper electrodes, which may double as structural reinforcement, to construct a building or structure that can absorb, store and discharge electricity similar to a battery or capacitor. This type of integrated building and battery system would have substantial advantages over existing systems for both conventional and alternative energy storage purposes highly due to its substantial mass. Additionally, the system would be able to power electric appliances and equipment when needed. Furthermore, this system would presumably be more economical than conventional battery systems due to the multi-purposing of materials.

To the best of Applicant's knowledge, the research and investigation in this field has not progressed beyond basic investigation. At this time, to the best of applicant's knowledge, no commercially viable concrete battery system has been developed. While many challenges exist to the development of a commercially viable concrete battery system, one significant challenge is the issue of scale of the structure. While small, experimental, single-block concrete battery systems exist, to the best of applicant's knowledge, no large scale building structures can or have been made to serve as concrete batteries. One reason—and one difficult challenge—is that in such small scale experimental concrete battery devices, any concrete electrolyte, and the metal rebar structures serving as the anode and cathode, typically have incompatible linear coefficients of thermal expansion. In other words, the concrete and the metal expand at different rates as temperature increases. While this incompatibility does not present a problem to a small test block, when its effect is considered at the scale of a large concrete structure such as a bridge piling, a highway overpass, or the structure of a building, this incompatibility is a significant problem, which will result in concrete cracking, spalling and possibly structural failure.

While existing work on concrete batteries has acknowledged and explored many of the electrical performance factors, it has neglected to acknowledge and account for the structural integrity factor of the concept, which is crucial to wide-spread commercialization of the concept. In almost all cases, existing studies employ material combinations that will reduce the structural viability of a concrete object by having made it perform electrically.

Thus, there is a need for energy storage building modules that not only perform well electrically but also possess the structural characteristics suitable for use on a large infrastructural scale.

Additionally, there is a need for development of significant volume and capacity batteries for storage of energy generated from renewable resources. One of the main hurdles for most forms of renewable energy to overcome is energy storage and grid balancing. Energy storage is a huge factor in maximizing the efficiency of any electric grid but is absolutely crucial for things like solar photovoltaic collection to become a viable solution for humanity's energy needs. To supply the world with even close to enough electricity from wind, waves, rain, and sunlight, etc., the world will need a nearly unfathomable amount of batteries or other forms of energy storage to match our current demand and usage patterns. These demands are continually rising. The amount of batteries we would need to be able to generate and store renewable energy that is commensurate with world energy demands—in order to achieve net-zero emissions—dwarfs the worlds current battery production. Moreover, current approaches to battery manufacturing are not particularly eco-friendly. Still further, many materials used in current state-of-the-art batteries, such as Lithium, are an even more finite material than petroleum, and are therefore just as monopolizable and controllable as is petroleum. Finite and precious resources are triggers for war.

On the other hand, concrete is one the largest and fastest growing industries in the world. It is therefore one of the industries most in need of “streamlining” in regards to environmental impact. Concrete is a material generally accessible throughout the world and to all social classes. Accordingly, it is the applicant's hope that the embodiments addressed herein can provide a solution to the nearly unlimited need for battery capacity, while reducing competition among nations and peoples for scarce material resources necessary to produce batteries in accordance with the current state-of-the-art.

Within virtually all modern concrete structures is a substructure of reinforcement, generally comprised of pre-stressed Steel rebar. It is crucial to the structural viability of a reinforced concrete object that the coefficients of thermal expansion (“CTE”) between the concrete matrix and internal reinforcement are compatible. Existing concrete battery embodiments employ “probes” of electrode material that are cast into concrete, or, tiny particles of electrode material that are mixed into concrete creating electrode layers. In almost all cases the electrode materials are copper and aluminum or zinc. None of these materials have a CTE that is compatible with common Portland cement-based concrete, which will lead to premature failure of a structure. Aluminum also will react with concrete chemically and releases tiny gas bubbles at its surface reducing its physical bond to the concrete.

Portland cement is the most common type of cement in general use around the world as a basic ingredient of concrete, mortar, stucco, and non-specialty grout. It was developed from other types of hydraulic lime in England in the mid-19th century, and usually originates from limestone. It is a fine powder, produced by heating limestone and clay minerals in a kiln to form clinker, grinding the clinker, and adding 2 to 3 percent of gypsum. Several types of Portland cement are available. The most common, called ordinary Portland cement (OPC), is grey, but white Portland cement is also available. Its name is derived from its similarity to Portland stone which was quarried on the Isle of Portland in Dorset, England.

The low cost and widespread availability of the limestone, shales, and other naturally-occurring materials used in Portland cement make it one of the lowest-cost building materials widely used over the last century. Concrete produced from Portland cement is one of the world's most versatile construction materials.

ASTM C150 defines Portland cement as “hydraulic cement (cement that not only hardens by reacting with water but also forms a water-resistant product) produced by pulverizing clinkers which consist essentially of hydraulic calcium silicates, usually containing one or more of the forms of calcium sulfate as an inter-ground addition.” The European Standard EN 197-1 uses the following definition: “Portland cement clinker is a hydraulic material which shall consist of at least two-thirds by mass of calcium silicates, (3 CaO.SiO2, and 2 CaO.SiO2), the remainder consisting of aluminum- and iron-containing clinker phases and other compounds. The ratio of CaO to SiO2 shall not be less than 2.0. The magnesium oxide content (MgO) shall not exceed 5.0% by mass.”

Unless stated otherwise herein, the term “Portland cement” as used herein is defined broadly, and means a material defined by ASTM C150, EN 197-1, or any other known or commonly understood definition of this material.

Clinkers make up more than 90% of the cement, along with a limited amount of calcium sulfate (CaSO4, which controls the set time), and up to 5% minor constituents (fillers) as allowed by various standards. Clinkers are nodules (diameters, 0.2-1.0 inch [5.1-25.4 millimetres]) of a sintered material that is produced when a raw mixture of predetermined composition is heated to high temperature. The key chemical reaction which defines Portland cement from other hydraulic limes occurs at these high temperatures (>1,300° C. (2,370° F.)) as Belite (Ca2SiO4) combines with Calcium Oxide (CaO) to form Alite (Ca3SiO5).

The most common use for Portland cement is in the production of concrete. Concrete is a composite material consisting of aggregate (gravel and sand), cement, and water. As a construction material, concrete can be cast in almost any shape desired, and once hardened, can become a structural (load bearing) element. Concrete can be used in the construction of structural elements like panels, beams, and street furniture, or may be cast-in situ for superstructures like roads and dams. These may be supplied with concrete mixed on site, or may be provided with ‘ready-mixed’ concrete made at permanent mixing sites. Portland cement is also used in mortars (with sand and water only), for plasters and screeds, and in grouts (cement/water mixes squeezed into gaps to consolidate foundations, road-beds, etc.).

When water is mixed with Portland cement, the product sets in a few hours, and hardens over a period of weeks. These processes can vary widely, depending upon the mix used and the conditions of curing of the product, but a typical concrete sets in about 6 hours and develops a compressive strength of 8 MPa in 24 hours. The strength rises to 15 MPa at 3 days, 23 MPa at 1 week, 35 MPa at 4 weeks, and 41 MPa at 3 months. In principle, the strength continues to rise slowly as long as water is available for continued hydration, but concrete is usually allowed to dry out after a few weeks and this causes strength growth to stop.

Five types of Portland cements exist, with variations of the first three according to ASTM C150.

Type I Portland cement is known as common or general-purpose cement. It is generally assumed unless another type is specified. It is commonly used for general construction, especially when making precast, and precast-prestressed concrete that is not to be in contact with soils or ground water. The typical compound compositions of this type are:
55% (C3S), 19% (C2S), 10% (C3A), 7% (C4AF), 2.8% MgO, 2.9% (SO3), 1.0% ignition loss, and 1.0% free CaO (utilizing Cement chemist notation).
A limitation on the composition is that the (C3A) shall not exceed 15%.

Type II provides moderate sulfate resistance, and gives off less heat during hydration. This type of cement costs about the same as type I. Its typical compound composition is:
51% (C3S), 24% (C2S), 6% (C3A), 11% (C4AF), 2.9% MgO, 2.5% (SO3), 0.8% ignition loss, and 1.0% free CaO.
A limitation on the composition is that the (C3A) shall not exceed 8%, which reduces its vulnerability to sulfates. This type is for general construction exposed to moderate sulfate attack, and is meant for use when concrete is in contact with soils and ground water, especially in the western United States due to the high sulfur content of the soils. Because of similar price to that of type I, type II is much used as a general purpose cement, and the majority of Portland cement sold in North America meets this specification.

Cement meeting (among others) the specifications for types I and II has become commonly available on the world market.

Type III has relatively high early strength. Its typical compound composition is:
57% (C3S), 19% (C2S), 10% (C3A), 7% (C4AF), 3.0% MgO, 3.1% (SO3), 0.9% ignition loss, and 1.3% free CaO.
This cement is similar to type I, but ground finer. Some manufacturers make a separate clinker with higher C3S and/or C3A content, but this is increasingly rare, and the general purpose clinker is usually used, ground to a specific surface area typically 50-80% higher. The gypsum level may also be increased a small amount. This gives the concrete using this type of cement a three-day compressive strength equal to the seven-day compressive strength of types I and II. Its seven-day compressive strength is almost equal to 28-day compressive strengths of types I and II. The only downside is that the six-month strength of type III is the same or slightly less than that of types I and II. Therefore, the long-term strength is sacrificed. It is usually used for precast concrete manufacture, where high one-day strength allows fast turnover of molds. It may also be used in emergency construction and repairs, and construction of machine bases and gate installations.

Type IV Portland cement is generally known for its low heat of hydration. Its typical compound composition is:
28% (C3S), 49% (C2S), 4% (C3A), 12% (C4AF), 1.8% MgO, 1.9% (SO3), 0.9% ignition loss, and 0.8% free CaO. The percentages of (C2S) and (C4AF) are relatively high and (C3S) and (C3A) are relatively low.
A limitation on this type is that the maximum percentage of (C3A) is seven, and the maximum percentage of (C3S) is thirty-five. This causes the heat given off by the hydration reaction to develop at a slower rate. However, as a consequence the strength of the concrete develops slowly. After one or two years the strength is higher than the other types after full curing. This cement is used for very large concrete structures, such as dams, which have a low surface to volume ratio. This type of cement is generally not stocked by manufacturers, but some might consider a large special order. This type of cement has not been made for many years, because Portland-pozzolan cements and ground granulated blast furnace slag addition offer a cheaper and more reliable alternative.

Type V is used where sulfate resistance is important. Its typical compound composition is:
38% (C3S), 43% (C2S), 4% (C3A), 9% (C4AF), 1.9% MgO, 1.8% (SO3), 0.9% ignition loss, and 0.8% free CaO.
This cement has a very low (C3A) composition which accounts for its high sulfate resistance. The maximum content of (C3A) allowed is 5% for type V Portland cement. Another limitation is that the (C4AF)+2(C3A) composition cannot exceed 20%. This type is used in concrete to be exposed to alkali soil and ground water sulfates which react with (C3A) causing disruptive expansion. It is unavailable in many places, although its use is common in the western United States and Canada. As with type IV, type V Portland cement has mainly been supplanted by the use of ordinary cement with added ground granulated blast furnace slag or tertiary blended cements containing slag and fly ash.

Types Ia, IIa, and IIIa have the same composition as types I, II, and III. The only difference is that in Ia, IIa, and IIIa, an air-entraining agent is ground into the mix. The air-entrainment must meet the minimum and maximum optional specification found in the ASTM manual. These types are only available in the eastern United States and Canada, only on a limited basis.

Types II(MH) and II(MH)a have a similar composition as types II and IIa, but with a mild heat.

Other types of cement exist that have favorable properties when compared to Portland cement and which may be used in the embodiments described below. One such type is “Sorrel” cement.

Sorel cement (also known as magnesia cement or magnesium oxychloride) is a non-hydraulic cement first produced by the French chemist Stanislas Sorel in 1867. Only a decade later, Sorel replaced zinc by magnesium in his formula and also obtained a cement with similar favorable properties. This new type of cement was stronger and more elastic than Portland cement, and therefore exhibited a more resilient behavior when submitted to shocks. The matter could be easily molded as plaster when freshly prepared, or machined on a lathe after setting and hardening. It was very hard, could be easily bound to many different types of materials (good adhesive properties), and colored with pigments. So, it was used to make mosaics and to mimic marble. After mixing with cotton crushed in powder, it was also used as a surrogate material for ivory to fabricate billiard balls resistant to shock.

Typically, Sorel cement is a mixture of magnesium oxide (burnt magnesia) with magnesium chloride with the approximate chemical formula Mg4Cl2(OH)6(H2O)8, or MgCl2.3Mg(OH)2.8H2O, corresponding to a weight ratio of 2.5-3.5 parts MgO to one part MgCl2.

Sometimes, Sorel cement refers to a zinc oxychloride cement, prepared from zinc oxide and zinc chloride instead of the magnesium compounds.

Sorel cement can withstand 10,000-12,000 psi (69-83 MPa) of compressive force whereas standard Portland cement can typically only withstand 7,000-8,000 psi (48-55 MPa). It also achieves high strength in a shorter time.

Sorel cement has a remarkable capacity to bond with, and contain, other materials. It also exhibits some elasticity, an interesting property increasing its capacity to resist shocks (better mechanical resilience), particularly useful for billiard balls.

The pour solution in wet Sorel cement is slightly alkaline (pH 8.5 to 9.5), but significantly less so than that of Portland cement (hyper alkaline conditions: pH 12.5 to 13.5).

Other differences between magnesium-based cements and Portland cement include water permeability, preservation of plant and animal substances, and corrosion of metals. These differences make different construction applications suitable.

In use, Sorel cement is usually combined with filler materials such as gravel, sand, marble flour, asbestos, wood particles and expanded clays.

Sorel cement is incompatible with steel reinforcement because the presence of chloride ions in the pore solution and the low alkalinity (pH<9) of the cement promote steel corrosion (pitting corrosion). However, the low alkalinity makes it more compatible with glass fiber reinforcement. It is also better than Portland cement as a binder for wood composites, since its setting is not retarded by the lignin and other wood chemicals.

The resistance of the cement to water can be improved with the use of additives such as phosphoric acid, soluble phosphates, fly ash, or silica.

The American Concrete Institute, Standard Number ACI 318-19, is considered the most current authority on national building codes for construction using reinforced concrete. The ACI 318-19 will be known and understood by the person of ordinary skill in the art, and is hereby incorporated by reference as if set forth herein.

Formulas and approaches to calculating the effects of CTE and CLTE for given materials, at given temperatures, for determining failure points of concrete with metallic and non-metallic reinforcement (e.g., rebar) are known. For example, such formulas and approaches are addressed in ACI 318-19 and in the published article “Effects of Thermal Loads on Concrete Cover of FRP Reinforced Elements: Theoretical and Experimental Analysis” Aiello, M. A., F. Focacci, and A. Nanni, ACI Materials Journal, Vol. 98, No. 4, July-August 2001, pp. 332-339; which is hereby incorporated by reference as if set forth fully herein.

### SUMMARY

Embodiments disclosed herein relate to building components. More specifically, the embodiments disclosed herein relate to “concrete batteries” that are engineered in a way to perform well electrically while not compromising the structural properties of a structure incorporating the concrete batteries for structural or load bearing purposes. Further, in some embodiments, the electrodes serve as additional structural support for the concrete electrolyte, thereby improving the load bearing ability of the resultant concrete battery. Further, the embodiments disclosed herein relate to concrete batteries that may be used in large structural applications using Portland cement, Sorrel cement, or similar materials, without significant cracking or spalling, due to use of anodes or cathodes which have a coefficient of linear expansion that is compatible with Portland cement, Sorrel cement, or similar materials, and/or which reacts with the cement and decays at a sustainable rate that could reduce or prevent structural failure of the cement used to build a large structure incorporating a plurality of such concrete batteries.

### BRIEF DESCRIPTION OF THE DRAWINGS

In the descriptions that follow, like parts or steps are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 illustrates a perspective view of an embodiment of the concrete battery disclosed herein, namely a flat block battery;

FIG. 2 illustrates a perspective view of another embodiment of the concrete battery disclosed herein, namely a cylindrical battery;

FIG. 3 illustrates a perspective view of another embodiment of the concrete battery disclosed herein, namely a sculptural shape battery; and

FIG. 4 illustrates a cross-sectional view of another embodiment of the concrete battery disclosed herein, namely a pipe battery.

### DESCRIPTION OF THE EMBODIMENTS

Each embodiment comprises a plurality of electrodes, a plurality of electrical conductors and connectors. Further, the preferred embodiment of the present invention comprises a plurality of material combinations and orientation options that will result in an integral structure or object with required architectural strength to suit its purpose as a load-bearing building element, and which is also able to absorb, store, and discharge electric energy like a battery or capacitor, while at the same time having a CLTE of all materials that is sufficiently similar under intended temperature variations for the structure sufficient to prevent cracking, spalling and structural failure of the cement-based electrolyte.

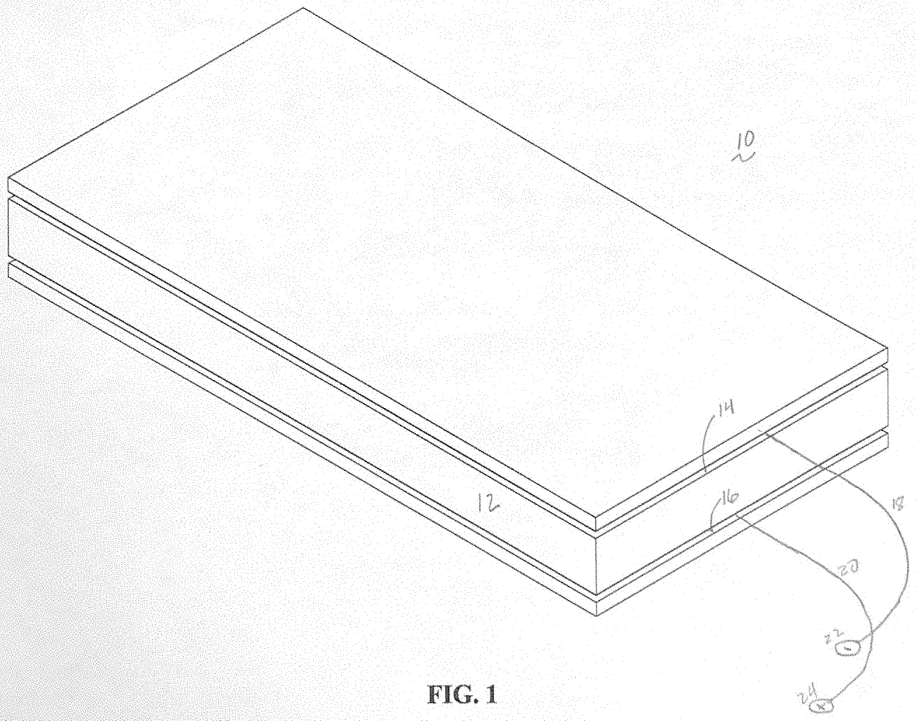

One embodiment of the present invention, the flat battery block 10 as seen in FIG. 1, comprises an electrolyte 12 comprising cement, such as Portland cement or Sorrel cement; two electrodes, namely an anode 14 and a cathode 16, two electric conductors 18, 20, which are connected to the anode 14 and cathode 16, respectively; and two electric connectors 22, 24. The electrolyte 12 forms the bulk of the structural component such as a wall, a floor, etc., using materials such as cement-based concrete. The plurality of electrodes 14, 16 can be dissimilar metals and/or carbon in perforated plate or mesh form that is embedded in and separated by the electrolyte, also serving as structural reinforcement. The electrodes 14, 16 are in parallel (physical rather than electrical) position and adjacent to the planar surface of the flat battery block 10. The electrodes 14, 16 are positioned within the electrolyte 12 in such a way that they are not exposed. One electric conductor 22, 24 leads to each electrode 14, 16 and provides electrical connection which can be used to charge or discharge the flat battery block 10.

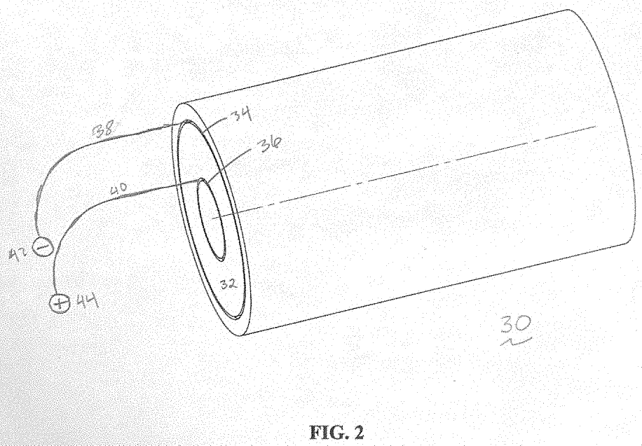

Another embodiment is the cylindrical battery block 30 as seen in FIG. 2, comprising comprises an electrolyte 32 comprising cement, such as Portland cement or Sorrel cement; two electrodes, namely an anode 34 and a cathode 36, two electric conductors 38, 40, which are connected to the anode 34 and cathode 36, respectively; and two electric connectors 42, 44. The cylindrical electrolyte 32 functions as the bulk of the structural component such as a rod, a pier, a footing, a pipe, or any cylindrical structure. Accordingly, each electrode 34, 36 comprises an electric conductor, an electric connector, and a cylindrical thin perforated plate or mesh that is concentric with the electrolyte block. The two electrodes 34, 36 are embedded in and separated by the electrolyte 32, but not exposed. The materials used for both electrodes and electrolyte are the same as in the flat battery block embodiment described above.

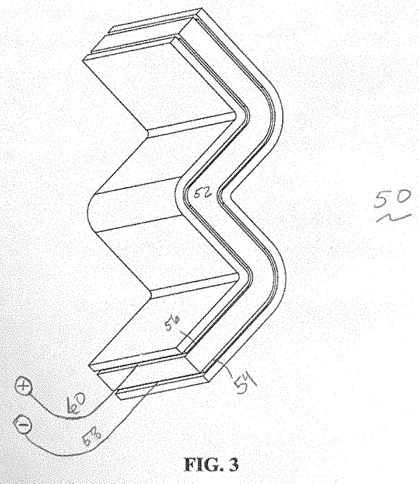

Yet another embodiment is the sculpted battery block 50 as seen in FIG. 3, comprises an electrolyte 52 comprising cement, such as Portland cement or Sorrel cement; two electrodes, namely an anode 54 and a cathode 36, two electric conductors 58, 60, which are connected to the anode 34 and cathode 36, respectively; and two electric connectors 42, 44. The electrolyte 52 functions as the bulk of the structural component such as a panel structure. This embodiment serves to demonstrate that the concrete battery disclosed herein may take any structural form consistent with concrete building techniques and the other requirements discussed below.

Embodiments disclosed herein employ electrode materials that will perform electrically and serve as viable internal reinforcement, maintaining excellent structural properties.

One example of this type of configuration is a substructure of zinc galvanized steel rebar alongside, but electrically separate from, a substructure of stainless steel rebar all cast within a common Portland cement-based concrete admixture. The galvanized steel rebar acts as the anode or negative electrode. The stainless steel rebar acts as the cathode or positive electrode. The result is a highly structurally sound and rechargeable energy storage building module. Adding a charge and maintaining upper charge levels from an exterior source, such as solar panels, will provide usable electricity in addition to providing galvanic protection of the zinc coated steel anode, in turn, greatly extending the longevity of a structure. Another embodiment of the invention is an all stainless concrete battery that has a stainless steel anode and a stainless steel cathode. The cell starts with no potential and no voltage but is polarized with an external power source to become a battery cell. Polarization consists of a series of charge cycles that will result in the establishment of a positive cathode and a negative anode, again, very structurally sound. There are many material combinations that fit within the scope of this invention.

Generally, linear thermal expansion of a solid is described by the following equation:

$$\frac{Δ L}{L} = {α}_{L} Δ T$$

L=change in length
L=original length
ΔT=change in temperature
α_{L}=linear coefficient of thermal expansion

In this equation, delta L is the change in length of the bar, delta T is the change in temperature of the bar, L is the original length before the temperature changed, and alpha is the linear coefficient of thermal expansion. The coefficient (“CLTE”) is a number that represents how much the material expands.

CLTE is typically measured in either micrometers of expansion per meter of original length, per increase in degrees temperature in Celsius (10-6 m/m° C.=1 μm/m° C.) or, less commonly, in inches per inch of original length, per increase in degrees of temperature in Rankine (10-6 in/in° R).

Using these units of measurement, the following materials have the following CLTE values:

| | Average CLTE in | Average CLTE in |
|---|---|---|
| Material | 10⁻⁶ m/m ° C. | 10⁻⁶ in/in ° R |
| Common Concrete | 14.5 | 8 |
| High performance concrete | 9.8 | 5.5 |
| Pure Portland cement | 11 | 6.11 |
| Common Steel | 12 | 6.7 |
| Nickel | 13 | 7.2 |
| Cast Iron | 10.4-11 | 5.9 |
| Ferrous Stainless steel | 9.9 | 5.5 |
| Austenitic 310 Stainless Steel | 14.4 | 8 |
| Gold | 14.2 | 8.2 |
| Cobalt | 12 | 6.7 |
| Monel Metal | 13.5 | 7.5 |
| Diamond (Carbon) | 1.1-1.3 | 0.611-0.722 |
| Invar | 1.5 | 0.833 |
| Barium ferrite | 10 | 5.56 |
| Scandium | 10.2 | 5.67 |
| Terbium | 10.3 | 5.72 |
| Yttrium | 10.6 | 5.89 |
| Cast Iron Gray | 10.8 | 6 |
| Promethium | 11 | 6.11 |
| Holmium | 11.2 | 6.22 |
| Hastelloy C | 11.3 | 6.28 |
| Inconel | 11.5-12.6 | 6.39-7 |
| Terne | 11.6 | 6.44 |
| Palladium | 11.8 | 6.56 |
| Beryllium | 12 | 6.67 |
| Cobalt | 12 | 6.67 |
| Thorium | 12 | 6.67 |
| Iron, pure | 12.0 | 6.67 |
| Lanthanum | 12.1 | 6.72 |
| Erbium | 12.2 | 6.78 |
| Samarium | 12.7 | 7.06 |
| Bismuth | 13-13.5 | 7.22-7.5 |
| Thulium | 13.3 | 7.39 |
| Uranium | 13.4 | 7.44 |
| Gold - platinum | 15.2 | 8.44 |
| Constantan | 15.2-18.8 | 8.44-10.4 |
| Gold - copper | 15.5 | 8.61 |
| Copper | 16-16.7 | 8.89-9.28 |
| Steel Stainless Austenitic (316) | 16.0 | 8.89 |
| Cupronickel 30% | 16.2 | 9 |
| Phosphor bronze | 16.7 | 9.28 |
| Steel Stainless Austenitic (304) | 17.3 | 9.61 |
| Bronze | 17.5-18 | 9.72-10 |
| Copper | 17.8 | 9.89 |
| Gunmetal | 18 | 10 |
| Brass | 18-19 | 10-10.6 |
| Manganin | 18.1 | 10.1 |
| German silver | 18.4 | 10.2 |
| Silver | 19-19.7 | 10.6-10.9 |
| Speculum metal | 19.3 | 10.7 |
| Fluorspar, CaF2 | 19.5 | 10.8 |
| Silicon Carbide | 2.77 | 1.54 |
| Kapton | 20 | 11.1 |
| Tin | 20-23 | 11.1-12.8 |
| Barium | 20.6 | 11.4 |
| Aluminum | 21-24 | 11.7-13.3 |
| Manganese | 22 | 12.2 |
| Calcium | 22.3 | 12.4 |
| Strontium | 22.5 | 12.5 |
| Duralumin | 23 | 12.8 |
| Magnalium | 23.8 | 13.2 |
| Solder lead - tin, 50% - 50% | 25 | 13.9 |
| Magnesium | 25-26.9 | 13.9-14.9 |
| Ytterbium | 26.3 | 14.6 |
| Lead | 29 | 16.1 |
| Thallium | 29.9 | 16.6 |
| Mica | 3 | 1.67 |
| Silicon | 3-5 | 1.67-2.78 |
| Cadmium | 30 | 16.7 |
| Indium | 33 | 18.3 |
| Europium | 35 | 19.4 |
| Tellurium | 36.9 | 20.5 |
| Selenium | 37 | 20.6 |
| Graphite, pure (Carbon) | 4-8 | 2.22 |
| Tungsten | 4.5 | 2.5 |
| Arsenic | 4.7 | 2.61 |
| Masonry, brick | 4.7-9.0 | 2.61-5 |
| Brick masonry | 5 | 2.78 |
| Molybdenum | 5 | 2.78 |
| Osmium | 5-6 | 2.78-3.33 |
| Topas | 5-8 | 2.78-4.44 |
| Cerium | 5.2 | 2.89 |
| Aluminum nitride | 5.3 | 2.94 |
| Sapphire | 5.3 | 2.94 |
| Marble | 5.5-14.1 | 3.06-7.83 |
| Zirconium | 5.7 | 3.17 |
| Hafnium | 5.9 | 3.28 |
| Hard alloy K20 | 6 | 3.33 |
| Chromium | 6-7 | 3.33-3.89 |
| Germanium | 6.1 | 3.39 |
| Iridium | 6.4 | 3.56 |
| Corundum, sintered | 6.5 | 3.61 |
| Tantalum | 6.5 | 3.61 |
| Praseodymium | 6.7 | 3.72 |
| Rhenium | 6.7 | 3.72 |
| Mercury | 61 | 33.9 |
| Niobium (Columbium) | 7 | 3.89 |
| Rhodium | 8 | 4.44 |
| Vanadium | 8 | 4.44 |
| Quartz, mineral | 8-14 | 4.44-7.78 |
| Alumina (aluminum oxide, Al2O3) | 8.1 | 4.5 |
| Steatite | 8.5 | 4.72 |
| Titanium | 8.5-9 | 4.72-5 |
| Potassium | 83 | 46.1 |
| Gadolinium | 9 | 5 |
| Platinum | 9 | 5 |
| Antimony | 9-11 | 5-6.11 |
| Ruthenium | 9.1 | 5.06 |
| Macor | 9.3 | 5.17 |
| Neodymium | 9.6 | 5.33 |
| Dysprosium | 9.9 | 5.5 |
| Lutetium | 9.9 | 5.5 |
| Steel Stainless Ferritic (410) | 9.9 | 5.5 |

The metals listed above generally have thermal expansion ranges within the range found in common Portland cement-based concrete admixtures and could be used in their pure forms, with themselves and in combinations with each other, depending on the application and specifics of the concrete admixture and/or the particular alloy or bi-metallic structure of these metals.

Metals with significantly greater or lesser CLTE's than that of common concrete can still be utilized in different ways. An example is coating a thin layer of zinc onto steel rebar. The zinc performs excellently as an anode but in its pure form has a higher expansion and contraction rate than the concrete and so is not suitable structurally for large commercial applications. The steel rebar has good structural properties but relatively poor electrical performance. When a zinc layer is applied to steel rebar, the electrical performance of the zinc is achieved, without disturbing the structural enforcement and thermal compatibility steel with concrete. The all stainless steel (there are many types of stainless) embodiment, and the zinc galvanized steel/stainless steel embodiment have excellent potential because they have reasonable electrical performance and are forms of rebar already available in the marketplace, though to the best of Applicant's knowledge neither has been used for the manufacture of a concrete battery.

Some of the more and less thermally expansive materials, which perform adequately electrically, but are not thermally compatible with Portland cement unless fully encased, are listed below, with their CLTE values. However, each may be useful with specific physical placement or may themselves be changed or combined as an alloy or bi-metallic component to be compatible.

| | Average CLTE in | Average CLTE in |
|---|---|---|
| Material | 10⁻⁶ m/m ° C. | 10⁻⁶ in/in ° R |
| Aluminum | 22 | 12 |
| Copper | 16.6 | 9.3 |
| Magnesium | 25 | 14 |
| Zinc | 29.7 | 16.5 |
| Silver | 19.5 | 10.7 |
| Lead | 28 | 15 |
| Brass | 18.7 | 10.4 |
| Bronze | 18 | 10 |
| Titanium | 8.4 | 4.8 |

Further, while this disclosure is primarily directed to concrete batteries made from Portland-cement using thermally compatible electrode materials, it should be understood that there are more and more non-Portland binder cements and CO2 absorbing concrete entering the market and gaining acceptance, that should fit within the scope of the disclosure herein, so long as the CLTE of these materials are compatible with electrode materials.

If the more expansive materials are not trapped and have room to move (expand and contract), they would not compromise the structural integrity of an object.

Less expansive materials that can be mixed with the ones above to create more “thermostructurally” sound alloys are as follows:

| | Average CLTE in | Average CLTE in |
|---|---|---|
| Material | 10⁻⁶ m/m ° C. | 10⁻⁶ in/in ° R |
| Graphite/Carbon | 2-6 | 1.1-3.4 |
| Silicon | 3 | 1.7 |
| Tungsten | 4.3 | 2.4 |

So different building applications will call for different concrete formulas which will call for different rebar/electrode scheduling. Applicant's investigation and research of particular combinations is continuing, but the above tables and disclosure are provided so as to inform as to the broad scope of the embodiments of the present invention and to address each genus of the present embodiments. Applicant also notes that some conductive materials which would be “incompatible” electrode/reinforcement materials are, or would be, compatible in lower quantities, but cannot fulfill tensile requirements. Applicant notes that by “lower quantities,” Applicant means a concrete to metal ratio with greater amounts of concrete and less metal to the point of structurally overcoming thermomechanical stress. As such, these materials may be candidates for alloying or bi-metallizing for an electrode with adequate CLTE properties and sufficient reinforcement strength.

Applicant also notes that, generally, the present embodiments are directed to load-bearing, structural elements of a building. Applicant hereby defines a load-bearing structural element as a component that is at least the size of a standard structural brick, namely 3⅝″×2¼″×7⅝″. As explained herein, in contrast to small, experimental concrete block batteries, the load bearing structural elements that are formed as concrete batteries in accordance with the present disclosure will benefit from the disclosure herein by achieving increased structural soundness and strength while having acceptable energy storage capacity.

It is also possible, and contemplated herein, to construct concrete battery modules in accordance with this disclosure with less structurally optimal electrode materials, but with the addition of other industry approved reinforcing materials such as polymer fibers, fiberglass, fiberglass/polymer composite rebar, basalt based products, etc., that are non-electrolytic, non-electrically conductive, and have no effect on the electrical performance of the concrete electrolyte, will allow it to perform with much greater structural performance. There are many different types of such additives approved and on the market.

As a further example, while steel and concrete do not share an identical CTE, they have a slight enough variance to pass the expansion test in most environments with great enough steel ratios to provide adequate structural reinforcement strength. Further, both copper and aluminum could be considered “compatible” if arranged properly and the ratios of concrete over metal are great enough to overcome any forces exerted by the expanding metals (and things like lack of bondage as in the case of aluminum). In the case of thin wire copper or aluminum meshes, the coverage of concrete and the low metal to concrete ratio will allow for the structure to exist without being damaged by the stresses caused by the difference between the CTE of the metals against the lesser CTE of the concrete, however, would require the addition of one or more of the above mentioned types of non-conductive reinforcements for structural viability in most applications.

It will also be understood that it is feasible to carbonize metal alloys such as copper to bring down the thermal expansion rates to a level more similar to that of common steel rebar. While not cost effective at the time of filing of this application, Applicant notes that this option is within the scope of the disclosure.

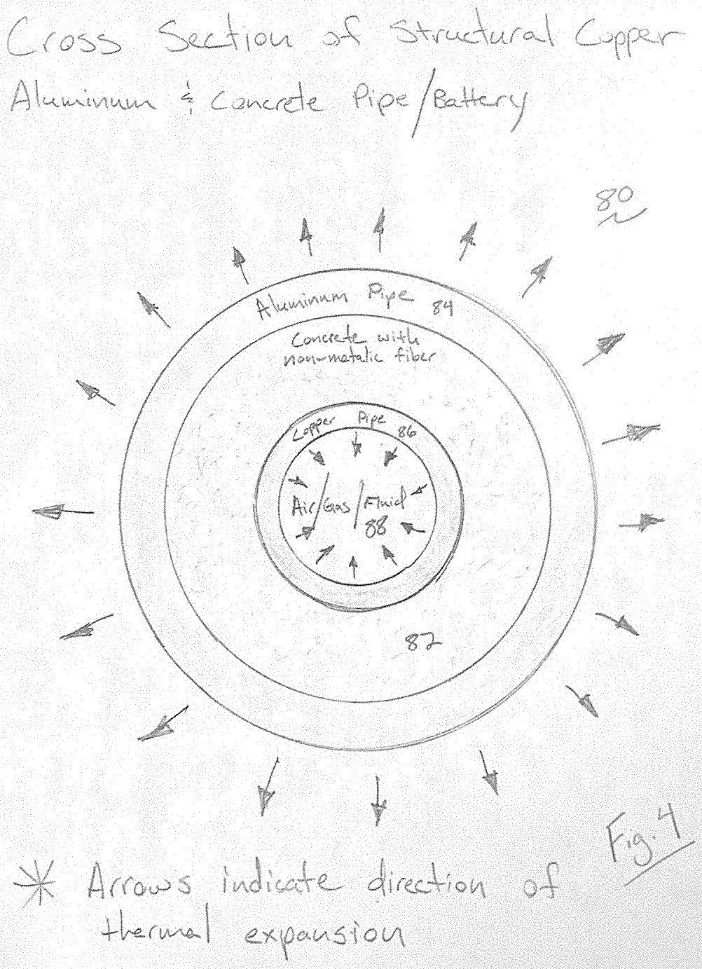

Another way to manage the issue of expanding and contracting electrode materials is to simply arrange modules in such a way as to allow for it. For example, with reference to FIG. 4, a cross-sectional view of a pipe battery 80 is presented, with a concrete electrolyte 82, an aluminum pipe anode 84 and a copper pipe cathode 86. In this particular embodiment, the aluminum and copper electrode materials are on the surfaces of the concrete/electrolyte, so they each are exposed to open space that will allow for the expansion of the metals without damaging the concrete. In this type of arrangement, the difference in expansion rates between the metals and concrete are less consequential than if the metals were imbedded into the concrete with no room to expand except into surrounding concrete, which is acceptable if there is not too much pressure. Due to that the layers are in a concentric cylinder formation, they will be less likely to delaminate upon temperature/size changes. Not only is this type of embodiment a very structurally sound battery module but it could also serve to transfer gasses or fluids through the hollow central channel 88. Scaled up, this type of module could serve as sections of a transportation tunnel that is capable of storing electricity. Coupled with solar or other charging sources, like geo-thermal or wind etc., modules of this nature could power the transfer of said fluids, gasses, or vehicles across vast expanses with no existing electric infrastructure.

Further, the present disclosure anticipates that some concrete batteries in accordance with the present disclosure will be poured monolithically and then cut into sections after concrete curing to allow for thermal size fluctuations. A battery pipe like this would have to be sectional, and then the necessary number of sections would be coupled and connected structurally and electrically. In extreme temperature applications these connection points would be engineered to allow for greater expansion and contraction.

As addressed herein, a focus and advantage of the embodiments of the present disclosure is the ability to create a concrete battery for use as a large structural component in such a way that the CLTE of the concrete electrolyte and the CLTE of the anode and cathode are within acceptable ranges compared to one another, such that cracking, spalling and degradation of the structural integrity of the concrete battery is avoided. As will be appreciated, the difference (delta) between the relevant CLTE's will differ depending upon numerous factors, such as the concrete formula, what structural requirements are needed for a particular application, and what environment the structure will be exposed to, e.g., large temperature swings vs. relatively constant temperatures.

The delta between relevant material CLTE's can be thought of as a “CLTE tolerance window.” The CLTE tolerance window for materials imbedded, with adequate coverage, in most Portland cement based formulations is relatively broad. For example, and without limitation, the CLTE tolerance window can range from between 5 10-6 m/m° C. to 30 10-6 m/m° C. for both the anode and cathode, as illustrated by the tables provided above. Applicant also notes that, depending upon the application, any CLTE tolerance widow between the concrete electrolyte and more expansive anode or cathode material, of less than or equal to 25 10-6 m/m° C., would be acceptable. For example, both copper and aluminum in the same metal to concrete ratios as a similar module reinforced with conventional steel rebar, with proper coverage, will not cause too much expansion damage (with acceptable coverage) in most common thermal environments, but copper and aluminum do not have but quite half of the tensile strength of conventional steel rebar. So in order to add enough copper/aluminum to overcome the lack of tensile strength, thermal expansion issues could arise in more extreme environments. In the case of a module with copper and aluminum electrodes, most structural load bearing applications will require the addition of a non-electrically conductive reinforcement material such as fiber reinforced polymer or FRP rebar.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments disclosed.

Insofar as the description above discloses any additional subject matter that is not within the scope of the claims below, the inventions are not dedicated to the public and the right to file one or more applications to claim such additional inventions is reserved.

What is claimed is:

1. A concrete battery for a structural application comprising:
an anode, comprising a conductive material with a first coefficient of linear thermal expansion of less than or equal to 30 10-6 m/m° C.;
a cathode comprising a conductive material with a second coefficient of linear thermal expansion of less than or equal to 30 10-6 m/m° C.;
an electrolyte comprising hardened cement with a third coefficient of linear thermal expansion of at least 5 10-6 m/m° C.;
wherein the anode is in physical contact with the hardened cement and provides structural reinforcement to the hardened cement;
wherein the cathode is in physical contact with the hardened cement and provides structural reinforcement to the hardened cement; and
wherein the anode, cathode and hardened cement are configured as a building component for load bearing.

2. The concrete battery of claim 1 wherein the hardened cement comprises Portland cement.

3. The concrete battery of claim 1 wherein the hardened cement comprises Sorrel cement.

4. The concrete battery of claim 1 wherein the hardened cement comprises Ferrock.

5. The concrete battery of claim 1 wherein the hardened cement comprises pozzolanic cement.

6. The concrete battery of claim 1 wherein the anode comprises a conductive material selected from the group consisting of: common steel, nickel, cast iron, ferrous stainless steel, austenitic 310 stainless steel, gold, cobalt, monel metal, diamond (carbon), invar, barium ferrite, scandium, terbium, yttrium, cast iron gray, promethium, holmium, hastelloy c, inconel, terne, palladium, beryllium, cobalt, thorium, pure iron, lanthanum, erbium, samarium, bismuth, thulium, uranium, gold-platinum alloy, constantan, gold-copper alloy, copper, steel stainless austenitic (316), cupronickel 30%, phosphor bronze, steel stainless austenitic (304), bronze, copper, gunmetal, brass, manganin, german silver, silver, speculum metal, fluorspar-caf2, silicon carbide, kapton, tin, barium, aluminum, manganese, calcium, strontium, duralumin, magnalium, solder (lead-tin, 50%-50%), magnesium, ytterbium, lead, thallium, mica, silicon, cadmium, indium, europium, tellurium, selenium, graphite, tungsten, arsenic, lithium, molybdenum, osmium, topas, cerium, aluminum nitride, sapphire, marble, zirconium, hafnium, hard alloy k20, chromium, germanium, iridium, sintered corundum, tantalum, praseodymium, rhenium, mercury, niobium, sodium, rhodium, vanadium, quartz, aluminum oxide, steatite, titanium, potassium, gadolinium, platinum, antimony, ruthenium, macor, neodymium, dysprosium, lutetium, and steel stainless ferritic (410).

7. The concrete battery of claim 1 wherein the cathode comprises a conductive material selected from the group consisting of common steel, nickel, cast iron, ferrous stainless steel, austenitic 310 stainless steel, gold, cobalt, monel metal, diamond (carbon), invar, barium ferrite, scandium, terbium, yttrium, cast iron gray, promethium, holmium, hastelloy c, inconel, terne, palladium, beryllium, cobalt, thorium, pure iron, lanthanum, erbium, samarium, bismuth, thulium, uranium, gold-platinum alloy, constantan, gold-copper alloy, copper, steel stainless austenitic (316), cupronickel 30%, phosphor bronze, steel stainless austenitic (304), bronze, copper, gunmetal, brass, manganin, german silver, silver, speculum metal, fluorspar-caf2, silicon carbide, kapton, tin, barium, aluminum, manganese, calcium, strontium, duralumin, magnalium, solder (lead-tin, 50%-50%), magnesium, ytterbium, lead, thallium, mica, silicon, cadmium, indium, europium, tellurium, selenium, graphite, tungsten, arsenic, lithium, molybdenum, osmium, topas, cerium, aluminum nitride, sapphire, marble, zirconium, hafnium, hard alloy k20, chromium, germanium, iridium, sintered corundum, tantalum, praseodymium, rhenium, mercury, niobium, sodium, rhodium, vanadium, quartz, aluminum oxide, steatite, titanium, potassium, gadolinium, platinum, antimony, ruthenium, macor, neodymium, dysprosium, lutetium, and steel stainless ferritic (410).

8. The concrete battery of claim 1 wherein the hardened cement further comprises non-conductive structural reinforcement dispersed throughout the hardened cement.

9. The concrete battery of claim 8 wherein the non-conductive structural reinforcement consists of one or more of the following materials: polymer fibers, fiberglass, fiberglass/polymer composite rebar, and basalt based products.

10. The concrete battery of claim 1 wherein the dimensions of the battery result in a volume that is equal to or greater than the volume of a structural brick measuring 3⅝ inches, by 2¼ inches, by 7⅝ inches.

11. A concrete battery for a structural application comprising:
an anode, comprising a conductive material with a first coefficient of linear thermal expansion;
a cathode comprising a conductive material with a second coefficient of linear thermal expansion;
an electrolyte comprising hardened cement with a third coefficient of linear thermal expansion;
wherein the anode is in physical contact with the hardened cement and provides structural reinforcement to the hardened cement;
wherein the cathode is in physical contact with the hardened cement and provides structural reinforcement to the hardened cement;
wherein the difference between the first coefficient of linear thermal expansion and the third coefficient of linear thermal expansion is less than or equal to 25 10-6 m/m° C.;
wherein the difference between the second coefficient of linear thermal expansion and the third coefficient of linear thermal expansion is less than or equal to 25 10-6 m/m° C.; and
wherein the anode, cathode and hardened cement are configured as a building component for load bearing.

12. The concrete battery of claim 11 wherein the hardened cement comprises Portland cement.

13. The concrete battery of claim 11 wherein the hardened cement comprises Sorrel cement.

14. The concrete battery of claim 11 wherein the hardened cement comprises Ferrock.

15. The concrete battery of claim 11 wherein the hardened cement comprises pozzolanic cement.

16. The concrete battery of claim 11 wherein the anode comprises a conductive material selected from the group consisting of: common steel, nickel, cast iron, ferrous stainless steel, austenitic 310 stainless steel, gold, cobalt, monel metal, diamond (carbon), invar, barium ferrite, scandium, terbium, yttrium, cast iron gray, promethium, holmium, hastelloy c, inconel, terne, palladium, beryllium, cobalt, thorium, pure iron, lanthanum, erbium, samarium, bismuth, thulium, uranium, gold-platinum alloy, constantan, gold-copper alloy, copper, steel stainless austenitic (316), cupronickel 30%, phosphor bronze, steel stainless austenitic (304), bronze, copper, gunmetal, brass, manganin, german silver, silver, speculum metal, fluorspar-caf2, silicon carbide, kapton, tin, barium, aluminum, manganese, calcium, strontium, duralumin, magnalium, solder (lead-tin, 50%-50%), magnesium, ytterbium, lead, thallium, mica, silicon, cadmium, indium, europium, tellurium, selenium, graphite, tungsten, arsenic, lithium, molybdenum, osmium, topas, cerium, aluminum nitride, sapphire, marble, zirconium, hafnium, hard alloy k20, chromium, germanium, iridium, sintered corundum, tantalum, praseodymium, rhenium, mercury, niobium, sodium, rhodium, vanadium, quartz, aluminum oxide, steatite, titanium, potassium, gadolinium, platinum, antimony, ruthenium, macor, neodymium, dysprosium, lutetium, and steel stainless ferritic (410).

17. The concrete battery of claim 11 wherein the cathode comprises a conductive material selected from the group consisting of common steel, nickel, cast iron, ferrous stainless steel, austenitic 310 stainless steel, gold, cobalt, monel metal, diamond (carbon), invar, barium ferrite, scandium, terbium, yttrium, cast iron gray, promethium, holmium, hastelloy c, inconel, terne, palladium, beryllium, cobalt, thorium, pure iron, lanthanum, erbium, samarium, bismuth, thulium, uranium, gold-platinum alloy, constantan, gold-copper alloy, copper, steel stainless austenitic (316), cupronickel 30%, phosphor bronze, steel stainless austenitic (304), bronze, copper, gunmetal, brass, manganin, german silver, silver, speculum metal, fluorspar-caf2, silicon carbide, kapton, tin, barium, aluminum, manganese, calcium, strontium, duralumin, magnalium, solder (lead-tin, 50%-50%), magnesium, ytterbium, lead, thallium, mica, silicon, cadmium, indium, europium, tellurium, selenium, graphite, tungsten, arsenic, lithium, molybdenum, osmium, topas, cerium, aluminum nitride, sapphire, marble, zirconium, hafnium, hard alloy k20, chromium, germanium, iridium, sintered corundum, tantalum, praseodymium, rhenium, mercury, niobium, sodium, rhodium, vanadium, quartz, aluminum oxide, steatite, titanium, potassium, gadolinium, platinum, antimony, ruthenium, macor, neodymium, dysprosium, lutetium, and steel stainless ferritic (410).

18. The concrete battery of claim 11 wherein the hardened cement further comprises non-conductive structural reinforcement dispersed throughout the hardened cement.

19. The concrete battery of claim 18 wherein the non-conductive structural reinforcement consists of one or more of the following materials: polymer fibers, fiberglass, fiberglass/polymer composite rebar, and basalt based products.

20. The concrete battery of claim 11 wherein the dimensions of the battery result in a volume that is equal to or greater than the volume of a structural brick measuring 3⅝ inches, by 2¼ inches, by 7⅝ inches.
